(19) United States
(12) Patent Application Publication
(10) Pub. No.: US 2014/0112029 A1
(43) Pub. Date: Apr. 24, 2014

(54) ELECTRIC POWER CONVERTING DEVICE

(71) Applicant: Lite-On Technology Corp., Taipei (TW)

(72) Inventors: CHIEN-YU LIN, TAIPEI (TW); WEI-LIEH LAI, TAIPEI (TW); YA-JHE LIU, TAIPEI (TW); YU-KANG LO, TAIPEI (TW); HUANG-JEN CHIU, TAIPEI (TW); CHENG-TING LIN, TAIPEI (TW)

(73) Assignee: Lite-On Technology Corp., Taipei (TW)

(21) Appl. No.: 14/019,914

(22) Filed: Sep. 6, 2013

(30) Foreign Application Priority Data
Oct. 19, 2012 (TW) 101138733

(51) Int. Cl. G05F 1/563; H02M 7/217

(52) U.S. Cl. CPC G05F 1/563; H02M 7/2176
USPC 363/21.12

(57) ABSTRACT

An electric power converting device includes a rectifier, a flyback voltage converter and a non-isolated voltage regulator. The rectifier is for converting an alternating current (AC) signal received from an AC power source into a direct current (DC) signal. The flyback voltage converter is electrically connected to the rectifier for transforming voltage of the DC signal from the rectifier to output a regulated DC signal. The non-isolated voltage regulator is electrically connected to the flyback voltage converter for reducing a voltage ripple of the regulated DC signal from the flyback voltage converter and for outputting an output voltage to a load.

### CROSS-REFERENCE TO RELATED APPLICATION

This application claims priority of Taiwanese Application No. 101138733, filed on Oct. 19, 2012.

### BACKGROUND OF THE INVENTION

1. Field of the Invention

The present invention relates to an electric power converting device, more particularly to an electric power converting device capable of reducing output voltage ripple and providing a stable output voltage to a load.

2. Description of the Related Art

Nowadays, rectifiers constructed from diodes are typically applied to conversion from alternating current (AC) into direct current (DC). Despite a low cost and a simple structure of such rectifiers, a significantly increased amount of low frequency harmonic waves attributed to serious nonlinear distortion of input current may result in a low power factor, and a high reactive power, causing a large amount of power consumption and an unstable output of electricity.

FIG. 1 shows a circuit diagram of a conventional electric power converting device 900, e.g., a power adapter. The conventional electric power converting device 900 generally has a two-stage configuration, and includes a boost power factor corrector 910 as an input stage and an isolated DC-to-DC converter 920 as an output stage. However, supply of electric power in some particular areas (e.g., Southeast Asia) may not be constantly stable. Thus, a capacitor (C) of the boost power factor corrector 910 may have to withstand relatively high voltage so as to prevent the conventional electric power converting device 900 from being damaged by unstable input voltage. The capacitor (C) capable of withstanding high voltage is generally an electrolytic capacitor, which is relatively large in size and expensive.

### SUMMARY OF THE INVENTION

Therefore, an object of the present invention is to provide an electric power converting device with relatively low cost, high power factor and high conversion efficiency.

Accordingly, an electric power converting device of the present invention is adapted to be electrically connected between an alternating current (AC) power source and a load for providing an output voltage to the load. The electric power converting device comprises a rectifier, a flyback voltage converter and a non-isolated voltage regulator.

The rectifier is adapted to be electrically connected to the AC power source for receiving an AC signal from the AC power source and for converting the AC signal into a direct current (DC) signal.

The flyback voltage converter is electrically connected to the rectifier for transforming voltage of the DC signal received from the rectifier to output a regulated DC signal.

The non-isolated voltage regulator is electrically connected to the flyback voltage converter for reducing a voltage ripple of the regulated DC signal received from the flyback voltage converter to output an output voltage. The non-isolated voltage regulator is adapted to be electrically connected to the load to provide the output voltage to the load.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit diagram illustrating a conventional electric power converting device;

FIG. 2 is a block diagram of a preferred embodiment of an electric power converting device according to the present invention;

FIG. 3 is a schematic circuit diagram of the preferred embodiment of the electric power converting device for illustrating a first example of a flyback voltage converter thereof;

FIG. 4 is a schematic circuit diagram of the preferred embodiment of the electric power converting device for illustrating a second example of the flyback voltage converter;

FIG. 5 is a schematic circuit diagram of the preferred embodiment of the electric power converting device for illustrating a third example of the flyback voltage converter;

FIG. 6 is a schematic circuit diagram of the preferred embodiment of the electric power converting device for illustrating a non-isolated voltage regulator thereof;

FIG. 7 is a plot for illustrating conversion efficiency of the electric power converting device according to the present invention; and

FIG. 8 is a plot for illustrating power factors of the electric power converting device according to the present invention;

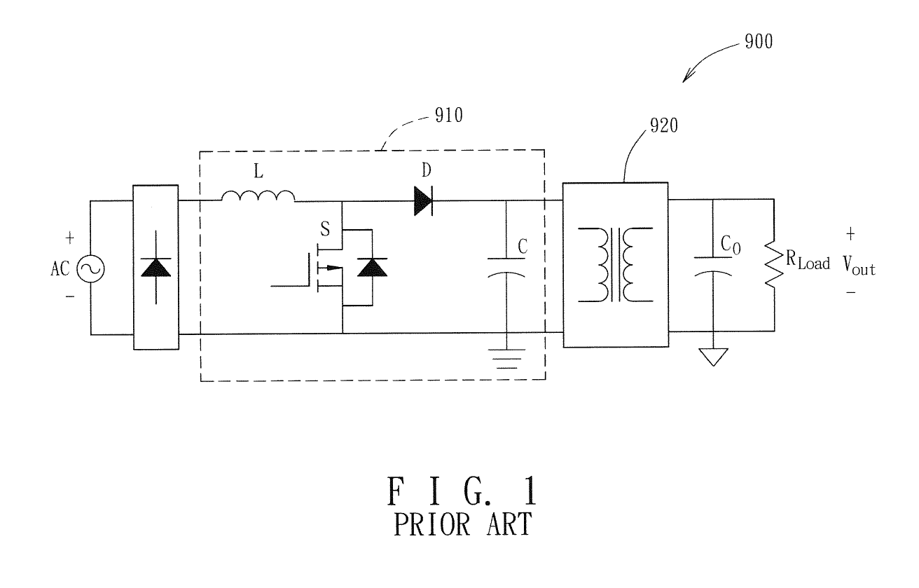

### DETAILED DESCRIPTION OF THE PREFERRED EMBODIMENT

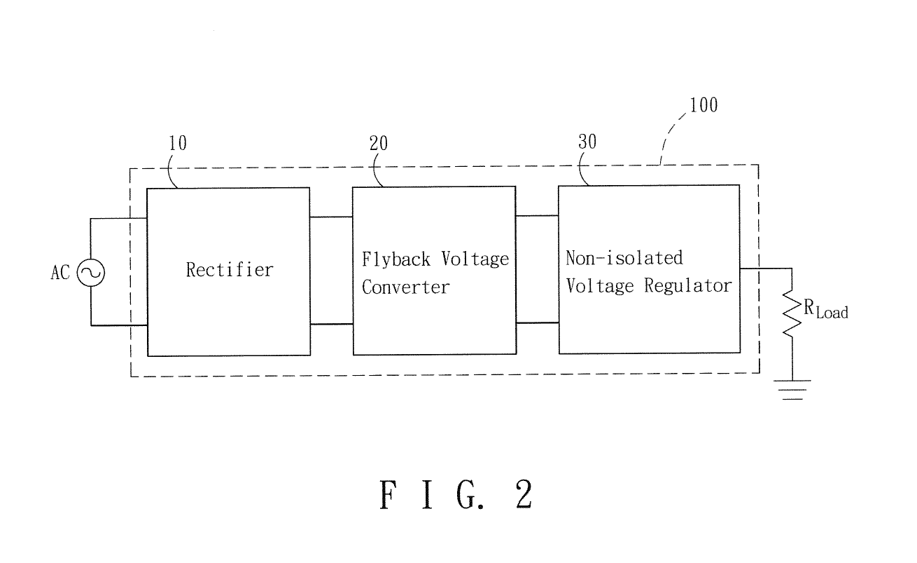

Referring to FIG. 2, a preferred embodiment of an electric power converting device 100 according to the present invention is shown. The electric power converting device 100 may be various types of switching power supply such as an adapter, an open-frame power supply, etc. The electric power converting device 100 of this preferred embodiment is adapted to be electrically connected between an alternating current (AC) power source and a load (R_{Load}) for providing an output voltage to the load (R_{load}). The electric power converting device 100 of this preferred embodiment includes a rectifier 10, a flyback voltage converter 20, and a non-isolated voltage regulator 30. The rectifier 10 is adapted to be electrically connected to the AC power source for receiving an AC signal from the AC power source and for converting the AC signal into a direct current (DC) signal. The flyback voltage converter 20 is electrically connected to the rectifier 10 for transforming voltage of the DC signal received from the rectifier 10 so as to improve a power factor of the electric power converting device 100 and to output a regulated DC signal. The non-isolated voltage regulator 30 is electrically connected to the flyback voltage converter 20 for reducing a voltage ripple of the regulated DC signal received from the flyback voltage converter 20 to output an output voltage, and is adapted to be electrically connected to the load (R_{Load}) to provide the output voltage to the load (R_{Load}).

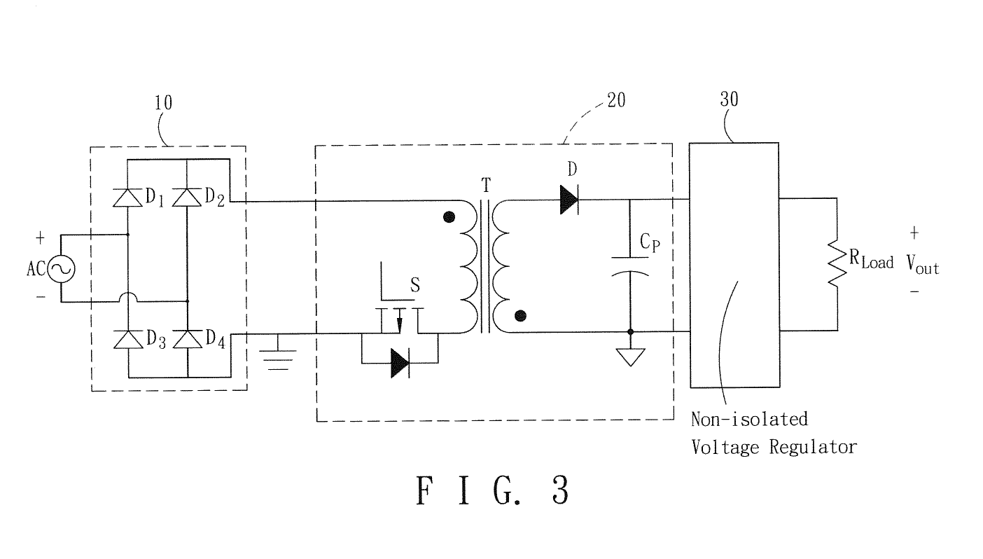

Referring to FIG. 3, the rectifier 10 includes a first diode (D₁), a second diode (D₂), a third diode (D₃) and a fourth diode (D₄).

The first diode (D₁) has an anode electrically connected to a positive terminal of the AC power source, and a cathode. The second diode (D₂) has an anode electrically connected to a negative terminal of the AC power source, and a cathode electrically connected to the cathode of the first diode (D₁). The third diode (D₃) has an anode that is grounded, and a cathode that is electrically connected to the anode of the first diode (D₁). The fourth diode (D₄) has an anode that is grounded, and a cathode that is electrically connected to the anode of the second diode (D₂).

As shown in FIG. 3, a first example of the flyback voltage converter 20 includes a transformer (T), a switching element (S), a conducting element, and a capacitor (C_{P}). The conducting element is electrically connected between the transformer (T) and the non-isolated voltage regulator 30. In the first example, the conducting element is a diode (D), and may be different types of semiconductor switches in other preferred embodiments of the present invention, such as a metal-oxide-semiconductor field-effect transistor (MOSFET), etc. Moreover, the capacitor (C_{P}) may be a multilayer ceramic capacitor (MLCC), a polymer capacitor, a liquid aluminum electrolytic capacitor, etc. The conducting element and the capacitor (C_{P}) of the present invention are not limited to the disclosure of this preferred embodiment.

The transformer (T) includes a primary winding having a pair of primary winding ends (i.e., a high-voltage end and a low-voltage end), and a secondary winding having a pair of secondary winding ends (i.e., a high-voltage end and a low-voltage end). In this example, the high-voltage end of the primary winding is electrically connected to the rectifier 10, and the low-voltage end of the primary winding is electrically connected to the switching element (S).

The switching element (S) is an N-type MOSFET and includes a drain serving as a connecting terminal, a gate serving as a control terminal, and a source serving as a grounded terminal. The drain (connecting terminal) is electrically connected to the low-voltage end of the primary winding of the transformer (T), and the gate (control terminal) is electrically connected to a pulse-width modulation (PWM) module (not shown).

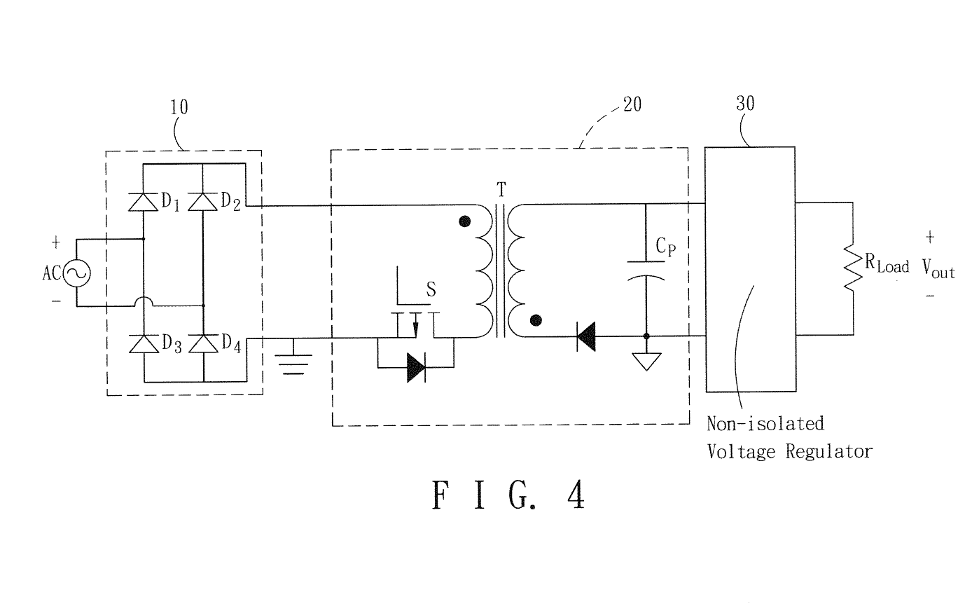

In the first example as shown in FIG. 3, the diode (D), i.e., the conducting element, has an anode electrically connected to the high-voltage end of the secondary winding of the transformer (T), and a cathode electrically connected to the non-isolated voltage regulator 30. Alternatively, as shown in FIG. 4, in a second example of the flyback voltage converter 20, the anode of the diode (D) is electrically connected to the non-isolated voltage regulator 30, and the cathode of the diode (D) is electrically connected to the low-voltage end of the secondary winding of the transformer (T).

The capacitor (C_{P}) has a first end electrically connected to the cathode of the diode (D), and a second end electrically connected to the low-voltage end of the secondary winding of the transformer (T). In this preferred embodiment, a common node between the second end of the capacitor (C_{P}) and the low-voltage end of the secondary winding of the transformer (T) is grounded.

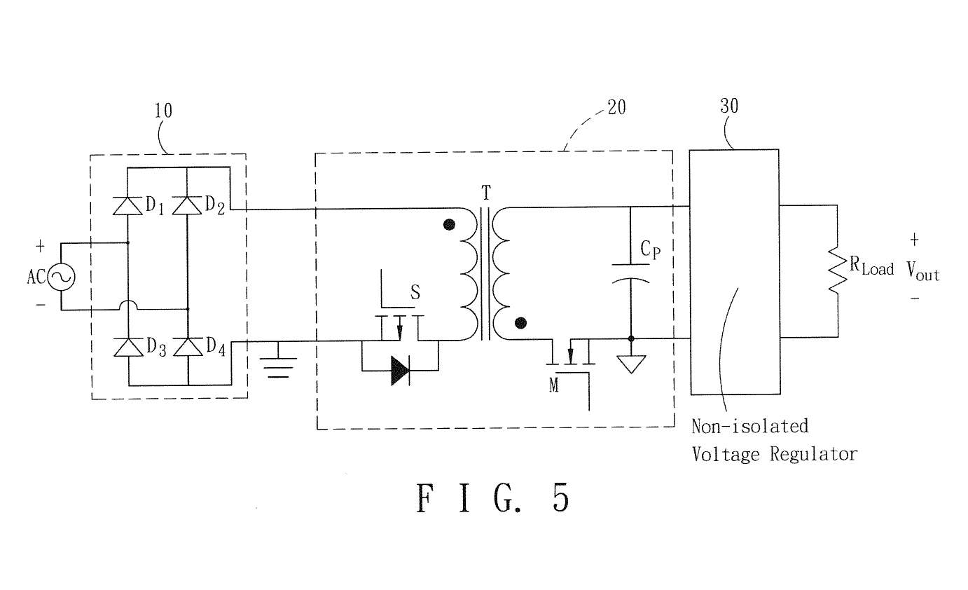

Moreover, in a third example of the flyback voltage converter 20 as shown in FIG. 5, the conducting element is a transistor (M) and is electrically connected to the low-voltage end of the secondary winding of the transformer (T). The transistor (M) has a first terminal electrically connected to the second end of the capacitor (C_{P}), a control terminal electrically connected to a PWM module (not shown), and a second terminal electrically connected to the low-voltage end of the secondary winding of the transformer (T). In the third example, a common node between the capacitor (C_{P}) and the transistor (M) is grounded. Nevertheless, the flyback voltage converter 20 is not limited to the examples of this preferred embodiment as long as the same effect can be achieved. For example, in a case that the conducting element is an N-type MOSFET and is electrically connected to the high-voltage end of the secondary winding of the transformer (T), a drain of the N-type MOSFET is electrically connected to the high-voltage end of the secondary winding, and a source of the N-type MOSFET is electrically connected to the non-isolated voltage regulator 30.

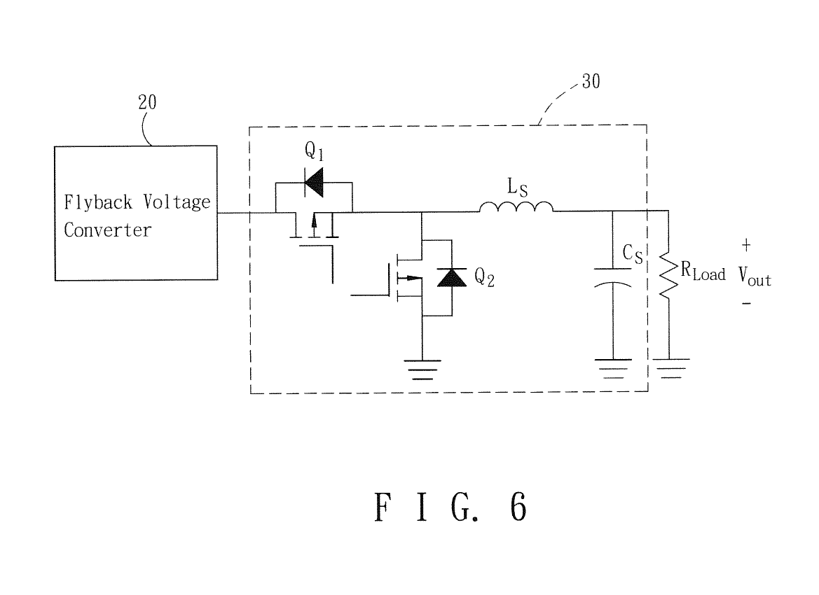

Referring to FIG. 6, the non-isolated voltage regulator 30 of this preferred embodiment is a synchronous-rectified buck converter, and includes a first switch (Q₁), a second switch (Q₂), an inductor (L_{S}), and a capacitor (C_{S}).

The first switch (Q1) is an N-type MOSFET having a drain electrically connected to the capacitor (C_{P}) of the flyback voltage converter 20, a gate (control terminal) electrically connected to a PWM module (not shown), and a source. The second switch (Q₂) is an N-type MOSFET having a drain electrically connected to the source of the first switch (Q1), a gate (control terminal) electrically connected to a PWM module (not shown), and a source that is grounded. The inductor (L_{S}) of the non-isolated voltage regulator 30 has two ends, one of which is electrically connected to the drain of the second switch (Q₂), and the other one of which is adapted to be electrically connected to the load (R_{Load}). The capacitor (C_{S}) of the non-isolated voltage regulator 30 may be, but is not limited to, a liquid aluminum electrolytic capacitor, a polymer capacitor, a multilayer ceramic capacitor (MLCC), etc. The capacitor (C_{S}) has two ends, one of which is electrically connected to the load (R_{Load}), and the other one of which is grounded. It is noted that the non-isolated voltage regulator 30 may be a different type of a voltage converter (such as a boost converter and a buck-boost converter), or a voltage regulator, etc. In practice, the non-isolated voltage regulator 30 is designed according to an output voltage of the flyback voltage converter 20. Moreover, the first and second switches Q1, Q2) may be P-type MOSFETs in other embodiments. The present invention is not limited to the disclosure of this preferred embodiment.

By appropriate control over the first and second switches (Q₁, Q₂) to switch between ON and OFF states using the PWM module, conversion efficiencies (η) of the non-isolated voltage regulator 30 under rated powers of 25%, 50%, 75% and 100% are shown in Table 1.

TABLE 1

| Vin (V) | Iin (A) | Vout (V) | Iout (A) | η ( % ) |
|---|---|---|---|---|
| 23 82 | 0.953 | 19.018 | 1.184 | 99.24 |
| 23.69 | 1.913 | 19.014 | 2.367 | 99.31 |
| 23.56 | 2.885 | 19.010 | 3.553 | 99.35 |
| 23.39 | 3.884 | 19.005 | 4.736 | 99.04 |

The data in Table 1 are obtained by experiment using the electric power converting device 100 of the preferred embodiment as a mobile power adapter. In Table 1, Vin is a voltage of the AC signal from the AC power source, Iin is a current of the AC signal from the AC power source, Vout is a voltage of the output voltage signal from the non-isolated voltage regulator 30, Iout is a current of the output voltage signal from the non-isolated voltage regulator 30, and η is the conversion efficiency of the non-isolated voltage regulator 30. As a result, the voltage ripple of the output voltage signal from the non-isolated voltage regulator 30 may be significantly reduced to 10% of that of an output voltage signal from the conventional electric power converting device (e.g. a mobile power adapter) with the same wattage level.

The rectifier 10 is for receiving the AC signal from the AC power source and for converting the AC signal into the DC signal. The flyback voltage converter 20 is for improving the power factor of the electric power converting device 100 to modify the DC signal as a sine wave with a phase identical to a phase of the AC signal, and is for outputting a regulated DC signal. The non-isolated voltage regulator 30 is for reducing the voltage ripple of the regulated DC signal received from the flyback voltage converter 20 so as to output an output voltage to the load (R_{load}). In other words, the single-stage flyback voltage converter 20 of the electric power converting device 100 is able to effectively improve the power factor of the electric power converting device 100, so that it is not necessary to use a high withstand-voltage electrolytic capacitor. Moreover, the non-isolated voltage regulator 30 of the electric power converting device 100 is able to effectively eliminate the output voltage ripple of the electric power converting device 100, so that the problem of high voltage ripple (e.g. 120 Hz) caused by lack of the high voltage electrolytic capacitor may be solved. Therefore, by virtue of the flyback voltage converter 20 and the non-isolated voltage regulator 30, the electric power converting device 100 may achieve the results of high power factor, high conversion efficiency and low voltage ripple at the same time, allowing adjustment of hold-up time of the electric power converting device 100 in accordance with required specification by controlling the capacitor (C_{P}).

It is noted that, there is no requirement of a high withstand-voltage capacitor, which has a relatively large size, at the primary winding of the transformer (T) of the flyback voltage converter 20. Further, the capacitor (C_{P}) at the secondary winding of the transformer (T) of the flyback voltage converter 20 is not necessarily to be a high withstand-voltage. Therefore, the size of the electric power converting device 100 may be reduced, and manufacturing cost may be lowered. Furthermore, an additional circuit for improving power factor is not needed because capacitive load is reduced. The size of the electric power converting device 100 may be reduced 20% with respect to the conventional electric power converting device, and therefore, the electric power converting device 100 may be applied to relatively small products, such as a mobile power adapter.

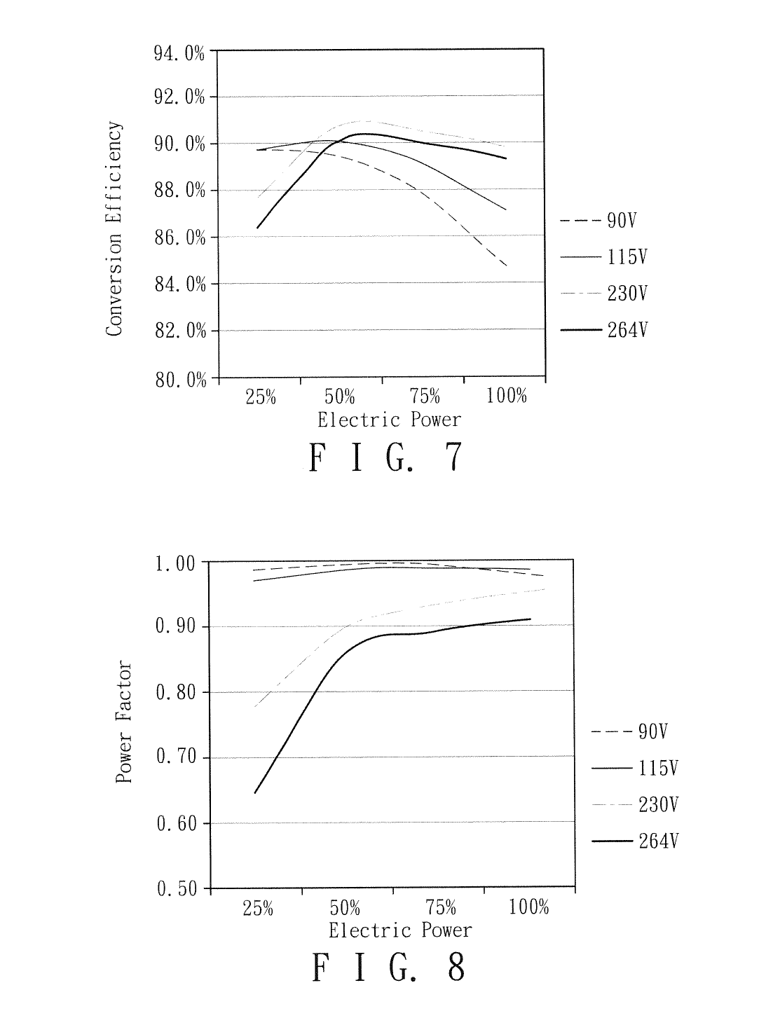

FIGS. 7 and 8 respectively show the conversion efficiency and the power factor of the electric power converting device 100 under different voltages of the AC signal (90V, 115V, 230V and 269V) with respect to different rated output power (25%, 50%, and 100%). The data in FIGS. 7 and 8 are also obtained by experiment using the electric power converting device 100 of the preferred embodiment as a mobile power adapter. It can be appreciated from FIGS. 7 and 8, the lowest average conversion efficiency of the electric power converting device 100 is 87.91%, and the power factor is higher than 0.9, meeting requirements in Energy Act. That is to say, the electric power converting device 100 of the present invention may achieve high power factor and high conversion efficiency at the same time.

To conclude, the single-stage flyback voltage converter 20 of the present invention is employed for improving the power factor of the electric power converting device 100 so as to reduce damage of the circuit of the electric power converting device 100 caused by unstable input AC power source, so that there is no need to use a high withstand-voltage capacitor with the flyback voltage converter 20. Accordingly, the electric power converting device 100 is suitable for use in areas where supply of commercial electric power may not be constantly stable or may be relatively high. Moreover, the non-isolated voltage regulator 30 is employed for reducing the voltage ripple of the secondary winding of the transformer (T) of the flyback voltage converter 20 to provide the output voltage. Therefore, within the regulated standard of output power, the electric power converting device 100 according to the present invention may enhance the power of the output voltage signal and may reduce the voltage ripple of the output voltage signal. In addition, an entire cost of the electric power converting device 100 according to the present invention may be 15% to 20% lower than that of a conventional electric power converting device provided with the high withstand-voltage electrolytic capacitor. Furthermore, the power factor of the electric power converting device 100 according to the present invention is higher than 0.9, meeting the requirements of Energy Act.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electric power converting device adapted to be electrically connected between an alternating current (AC) power source and a load for providing an output voltage to the load, said electric power converting device comprising:
a rectifier adapted to be electrically connected to the AC power source for receiving an AC signal from the AC power source and for converting the AC signal into a direct current (DC) signal;
a flyback voltage converter electrically connected to said rectifier for transforming voltage of the DC signal received from said rectifier so as to output a regulated DC signal; and
a non-isolated voltage regulator electrically connected to said flyback voltage converter for reducing a voltage ripple of the regulated DC signal received from said flyback voltage converter to output an output voltage, and adapted to be electrically connected to the load to provide the output voltage to the load.

2. The switching power supply as claimed in claim 1, wherein said flyback voltage converter includes:
a transformer including a primary winding having a pair of primary winding ends, one of which is electrically connected to said rectifier, and a secondary winding having a pair of secondary winding ends;
a switching element having a connecting terminal electrically connected to the other one of said primary winding ends of said primary winding of said transformer, a grounded terminal, and a control terminal;
a conducting element having two terminals electrically connected to one of said secondary winding ends of said secondary winding of said transformer and said non-isolated voltage regulator, respectively; and
a capacitor having a first end electrically connected to one of said terminals of said conducting element that is connected to said non-isolated voltage regulator, and a second end electrically connected to the other one of said secondary winding ends of said secondary winding of said transformer.

3. The electric power converting device as claimed in claim 2, wherein said secondary winding ends of said secondary winding of said transformer are a high-voltage end and a low-voltage end;
wherein said conducting element is a diode having an anode and a cathode serving as said terminals of said conducting element, respectively, said anode being electrically connected to said high-voltage end of said secondary winding of said transformer, said cathode being electrically connected to said non-isolated voltage regulator.

4. The electric power converting device as claimed in claim 2, wherein said secondary winding ends of said secondary winding of said transformer are a high-voltage end and a low-voltage end;
wherein said conducting element is a diode having an anode and a cathode serving as said terminals of said conducting element, respectively, said anode being electrically connected to said non-isolated voltage regulator, said cathode being electrically connected to said low-voltage end of said secondary winding of said transformer.

5. The electric power converting device as claimed in claim 2, wherein said conducting element is a semiconductor switch.

6. The electric power converting device as claimed in claim 2, wherein one of said primary winding ends is a high-voltage end of said primary winding and the other one is a low-voltage end of said primary winding, and one of said secondary winding ends is a high-voltage end of said secondary winding and the other one is a low-voltage end of said secondary winding;
wherein said connecting terminal of said switching element is electrically connected to said low-voltage end of said primary winding; and
wherein one of said terminals of said conducting element is electrically connected to said high-voltage end of said secondary winding.

7. The electric power converting device as claimed in claim 2, wherein one of said primary winding ends is a high-voltage end of said primary winding and the other one is a low-voltage end of said primary winding, and one of said secondary winding ends is a high-voltage end of said secondary winding and the other one is a low-voltage end of said secondary winding;
wherein said connecting terminal of said switching element is electrically connected to said low-voltage end of said primary winding; and
wherein one of said terminals of said conducting element is electrically connected to said low-voltage end of said secondary winding.

8. The electric power converting device as claimed in claim 1, wherein said non-isolated voltage regulator includes:
a first switch having a first terminal electrically connected to said flyback voltage converter, a second terminal, and a control terminal;
a second switch having a first terminal electrically connected to said second terminal of said first switch, a second terminal that is grounded, and a control terminal;
an inductor having a first end electrically connected to said first terminal of said second switch, and a second end adapted to be electrically connected to the load; and
a capacitor having a connecting end adapted to be electrically connected to the load, and a grounded end.

9. The electric power converting device as claimed in claim 1, wherein said non-isolated voltage regulator is one of a buck converter, a boost converter, a buck-boost converter, and a voltage regulator.

10. The electric power converting device as claimed in claim 1, wherein said electric power converting device is one of an adapter and an open-frame electric power converting device.
